(19) United States
(12) Patent Application Publication
(10) Pub. No.: US 2011/0172887 A1
(43) Pub. Date: Jul. 14, 2011

(54) VEHICLE ASSEMBLY CONTROL METHOD FOR COLLABORATIVE BEHAVIOR

(76) Inventors: David R. Reeve, Chapel Hill (AU); Malcolm B. Jones, Bracken Ridge (AU); Andreas F. Ramm, Deception Bay (AU)

(21) Appl. No.: 12/957,091

(22) Filed: Nov. 30, 2010

Related U.S. Application Data
(60) Provisional application No. 61/265,281, filed on Nov. 30, 2009.

(51) Int. Cl. G06F 7/00; G01C 21/00

(52) U.S. Cl. 701/50; 701/1

(57) ABSTRACT

The present invention relates to a method for controlling vehicle assemblies using respective controllers. Each controller is in communication with a database. Each controller is configured to perform the step of placing a bid in the database in relation to a task to be performed by the vehicle assembly. The controller then determines whether the placed bid was successful and, subsequent to determining that the placed bid was successful, controls the vehicle assembly to perform the task.

### CROSS-REFERENCE TO RELATED APPLICATION

This application claims priority in U.S. Provisional Patent Application No. 61/265,281, filed Nov. 30, 2009, which is incorporated herein by reference.

### BACKGROUND

1. Field of the Invention

The present invention generally relates to a method for controlling a vehicle assembly using a controller. The present invention has particular, although not exclusive application to controllers for agricultural vehicle assemblies.

2. Description of the Related Art

The reference to any prior art in this specification is not, and should not be taken as an acknowledgement or any form of suggestion that the prior art forms part of the common general knowledge.

Autonomous or driverless vehicles can perform tasks in hazardous environments and thereby remove the possibility of operators becoming injured or even killed.

Some environments require multiple autonomous vehicles to operate in the same geographic area. Coordinating the vehicles to co-operate effectively is a difficult task, which can be further complicated as the number of vehicles increase.

### SUMMARY OF THE INVENTION

According to one aspect of the present invention, there is provided a method for controlling a vehicle assembly using a controller, the method including the steps of:

placing, with the controller, a bid in relation to an task to be performed by the vehicle assembly;

determining, with the controller, that the placed bid was successful; and

controlling, with the controller, the vehicle assembly to perform the task subsequent to determining that the placed bid was successful.

Prior to the step of placing, the method may further include the step of identifying the task to be performed. The step of identifying may involve searching or polling.

Prior to the step of placing, the method may further include the step of determining a cost for performing the task, the bid being placed in accordance with the determined cost. The cost may be determined using database information to calculate one of: the distance of the vehicle assembly from a location where the task is to be performed, or the travel time of the vehicle assembly to a location where the task is to be performed. The step of determining a cost may involve determining a travel path of the vehicle assembly to the location where the task is to be performed.

In one embodiment, the step of determining that the placed bid was successful involves determining that the bid associated with the vehicle assembly was a lowest cost bid placed for the task when the vehicle assembly is ready to perform the task.

Prior to the step of placing, the method may further include the step of placing a succession of prior bids in relation to the task, and the step of determining may involve determining that the placed bid was successful when compared with bids from one or more other vehicle assemblies. Each step of placing may involve placing a bid in a bid field of the database associated with the vehicle assembly.

In one embodiment, the task to be performed is spraying a crop swath using a sprayer of the vehicle assembly, and the step of controlling involves spraying the crop swath.

The method may further include the step of updating a database of the controller using synchronization information so that the database mirrors databases of other vehicle assembly controllers. The step of updating the database may be performed periodically.

The method may further include the step of placing another bid in relation to another potential task to be performed by the vehicle assembly.

According to another aspect of the present invention, there is provided a method for controlling vehicle assemblies using respective controllers, each controller in communication with a database, each controller configured to perform the steps of:

placing a bid in the database in relation to a task to be performed by the vehicle assembly;

determining whether the placed bid was successful; and

controlling the vehicle assembly to perform the task subsequent to determining that the placed bid was successful.

In one embodiment, the database includes task records relating to respective tasks to be performed, and each controller is configured to place one or more bids in the database in relation to respective tasks.

In one embodiment:

the database receives a succession of cost bids for first and second vehicle assemblies; and

when the first vehicle assembly is ready to perform the task, the first vehicle assembly can determine that its most recent cost bid is successful as it is lower than the most recent cost bid of the second vehicle assembly.

Optionally, the database is distributed with mirrored and synchronized versions of the database being located proximal to respective controllers. Alternatively, the database is located at a single location.

According to another aspect of the present invention, there is provided a vehicle controller for controlling a vehicle assembly, the controller configured to:

place a bid in relation to a task to be performed by the vehicle assembly;

determine that the placed bid was successful; and

control the vehicle assembly to perform the task subsequent to determining that the placed bid was successful.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram showing a sprayer in accordance with an embodiment of the present invention;

FIG. 2 is a schematic diagram of a spraying system for spraying a field including sprayers of FIG. 1;

FIG. 3 is a block diagram of a control system for controlling the sprayer of FIG. 1;

FIG. 4 is a schematic diagram of a database of the control system of FIG. 3;

FIG. 5 is a flowchart of a control method performed by a controller of the control system of FIG. 3.

### DETAILED DESCRIPTION OF PREFERRED EMBODIMENTS

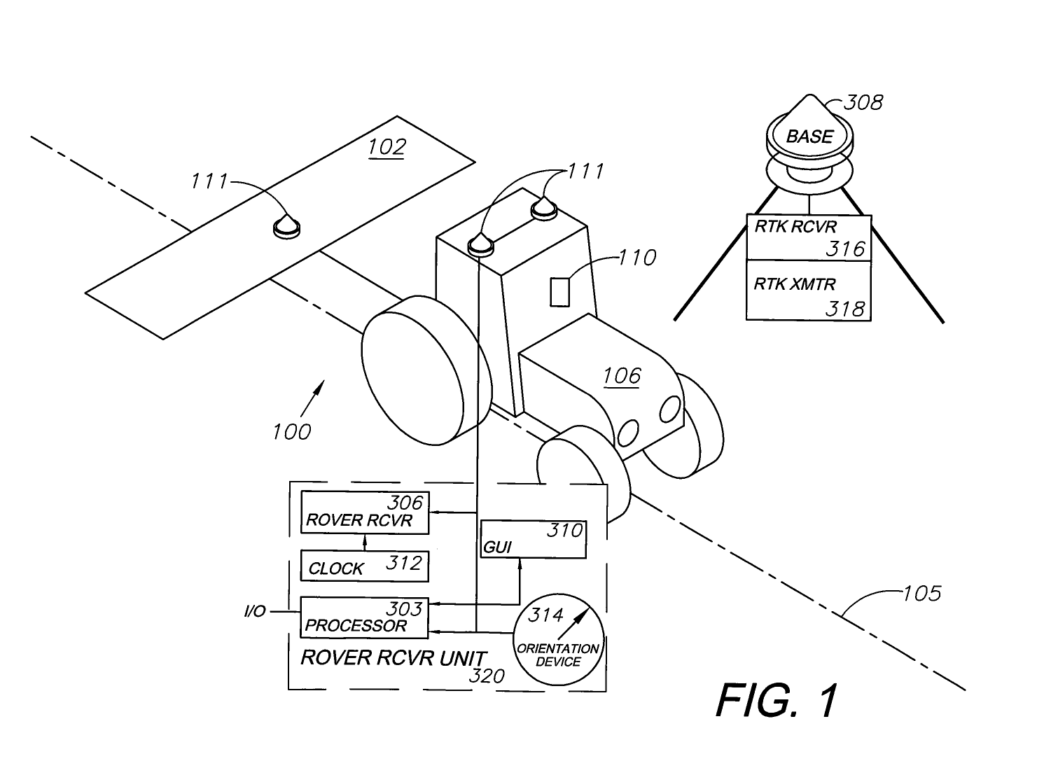

FIG. 1 shows a sprayer vehicle assembly 100 (hereinafter referred to as “sprayer”) for spraying a crop swath 104. The sprayer 100 includes a vehicle 106 which tracks along the swath 104, and a spray unit 102 fitted to the vehicle 106 and for spraying the swath 104. A control system 110 is provided onboard the vehicle 106 for automatically controlling the position of the sprayer 100 relative to the swath during spraying. The control system 110 can automatically control the steering and speed of the vehicle 106, and also activates the spray unit 102.

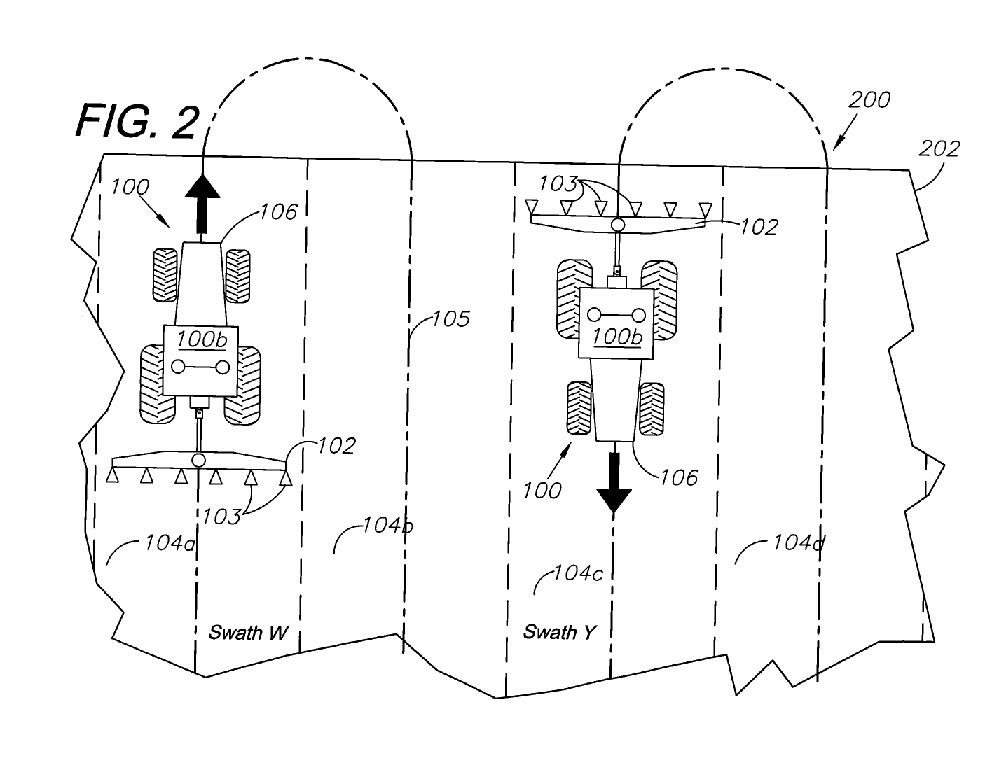

FIG. 2 shows a spraying system 200 for spraying a field 202. The spraying system 200 includes many like driverless, autonomous sprayers 100 which perform collaborative behaviour to spray the field 202. A command centre 204 places tasks relating to spraying crop swaths 104 of the field 202 within a common database. The database is distributed, with mirrored local versions of the database being located proximal to respective control systems 110 to improve information access speed. A mirrored local version of the database is also located proximal to a control system of the command center 204. While the sprayers 100 and command centre 204 directly access information in their local version of the database which can lead to discrepancies in information between local versions, the local versions of the database are periodically synchronized so that they generally include the same information. The sprayers 100 can access the database, which represents a “real world view” of the spraying system 200, and effectively act as automatons performing a bidding-based control method to collaboratively spray the field 202 as described in detail below.

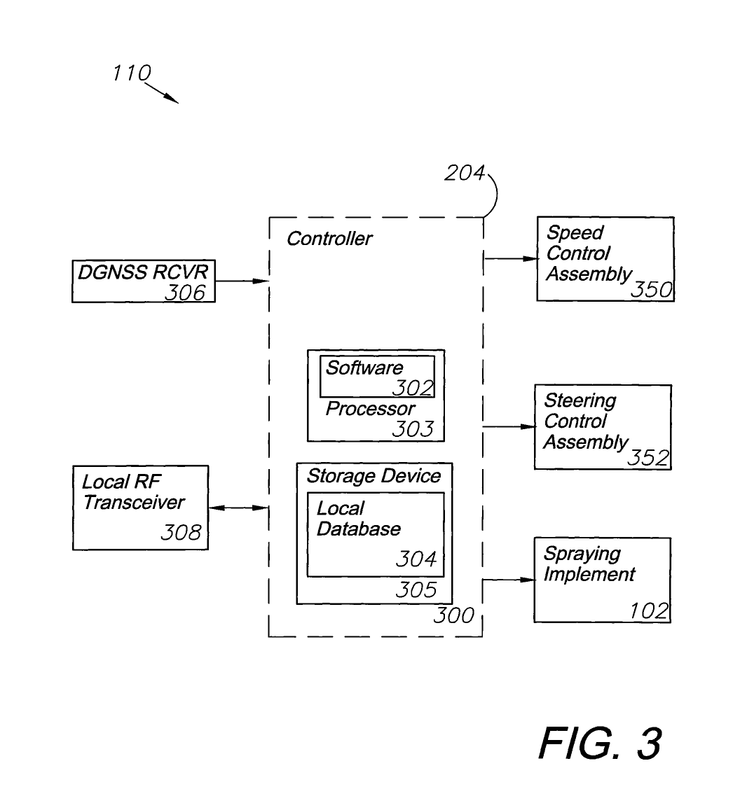

Turning to FIG. 3, each control system 110 includes a central controller 300 in which a software product 302 is contained in resident memory. In turn, the software product 302 contains computer readable instructions for execution by a processor 303 of the controller 300 to perform the control method outlined below. The processor 303 is interfaced to a storage device (e.g. hard disc) containing a local version of the database 304 which includes, among other data relating to the control system 110, geographical location information relating to the field 202 being sprayed by the sprayers 100. In use, each controller 300 uses this database information to generate a path and control the motion of the vehicle 106, as described in WO/2008/080193 which is incorporated herein by reference.

The processor 303 is electrically coupled to terminal ports for connecting to receiver 306, transceiver 308, actuator assemblies 350, 352 of the vehicle 106 and the spray unit 102.

Elaborating further, the control system 110 includes a differential global navigation satellite system (DGNSS) receiver 306 for sensing the location of the sprayer 100. Global navigation satellite systems (GNSSs) are broadly defined to include the Global Positioning System (GPS, U.S.), Galileo (proposed, Europe), GLONASS (Russia), Beidou (China), Compass (proposed), the Indian Regional Navigational Satellite System (IRNSS), QZSS (Japan, proposed) and other current and future positioning technology using signals from satellites, with or without augmentation from terrestrial sources. The receiver 306 receives location information relating to the vehicle 106 (and therefore the spray unit 102) which the controller 300 uses to determine the vehicle location and pose that, in turn, is stored in the database 304. The controller 300 can also determine the speed of the vehicle 100 using this information.

A local radio frequency (RF) transceiver 308 transmits synchronization information to, and receives synchronization information from, other local RF transceivers of the sprayers 100 and command center 204. As previously discussed, the synchronization information is used to update the local versions of the database 304 so that the versions all generally include the same information.

The control system 110 includes two driven outputs in the form of vehicle speed control assembly 350 and vehicle steering control assembly 352. During automatic control of the vehicle 106, the controller 300 controls the vehicle speed control assembly 350 (including an accelerator of the vehicle 106) so that the vehicle 106 automatically travels at a desired speed along a swath 104 or generated path. At this time, the controller 300 can also control the vehicle steering control assembly 352 (including a steering valve block of the vehicle 106) so that the vehicle 106 is automatically steered.

The control system 110 further includes the spray unit 102 controlled by the controller 300 and able to spray the crop swath 104 with fertilizer or pesticide as required.

According to an embodiment of the present invention, there is provided a method for controlling the sprayers 100a, 100b using respective onboard controllers 300. As previously explained, each controller 300 is in communication with the local version of the database 304. Each controller 300 is configured to perform the step of placing a succession of bids in the database 304 in relation to a task to be performed by the associated sprayer 100. When the associated sprayer 100 completes its current task, the controller 300 determines whether the latest placed bid was successful when compared with current bids from one or more other sprayers 100. Each controller 300 is further configured to perform the step of controlling the sprayer 100 to perform the task subsequent to determining that the latest placed bid was successful.

As previously discussed, each sprayer 100 effectively acts as an automaton and is willing to perform tasks related to task records placed in the common database 304 by the command centre 204. Each sprayer 100 does not directly communicate with the other sprayers 100 or the command centre 204, but rather obtains its information and “real world view” from the database 304. The control method performed by each controller 300 is described in detail below.

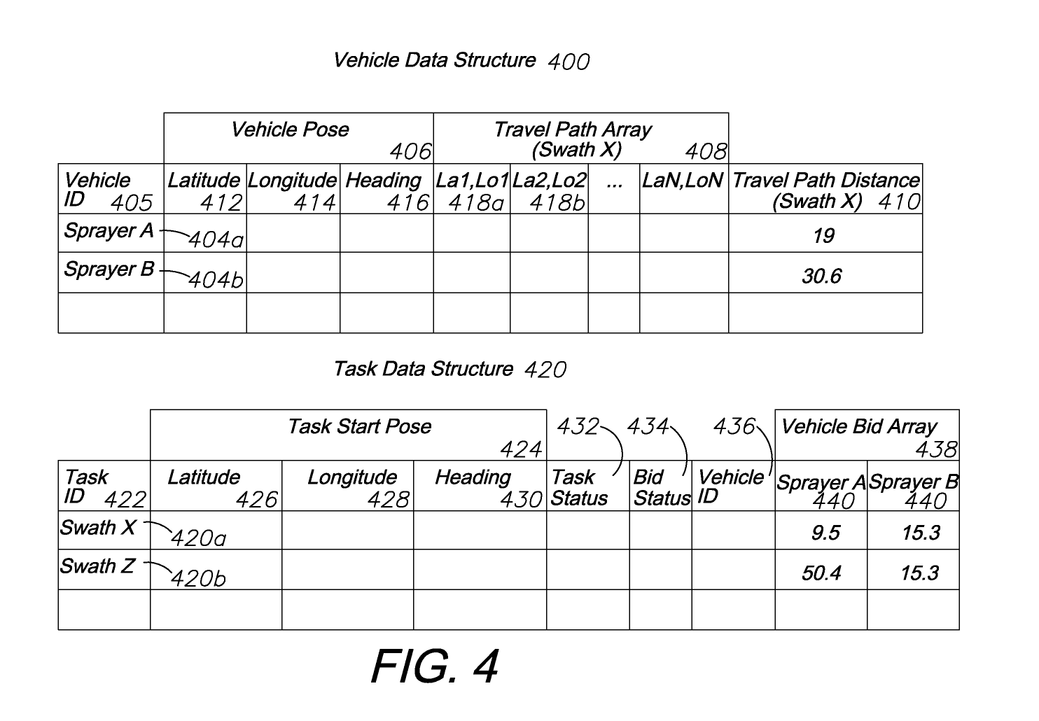

FIG. 4 shows the relevant portion of the database 304 including a vehicle data structure 400 and a task data structure 402. The vehicle data structure 400 includes sprayer information relating to each sprayer 100, whereas the task data structure 402 includes task information relating to the tasks to be performed (i.e. swaths 104 to spray) by the sprayers 100.

The vehicle data structure 400 includes a plurality of sprayer records 404 relating to respective sprayers 100 of the spraying system 200. Each sprayer record 404 includes a vehicle identification field 405 which relates to the unique identity of each sprayer 100, a vehicle pose field 406 which relates to the pose of the sprayer 100, a travel path array 408 which relates to the future travel path of the sprayer 100 from the vehicle pose field 406 to the start of a task to be performed (indicated in task starting pose field 424 below), and a travel path distance field 410 which relates to the distance of the sprayer 100 along the travel path array 408. Multiple travel path arrays 408 and travel path distance fields 410 can be provided in database 304 for respective tasks.

The vehicle pose field 406 includes a latitude subfield 412, a longitude subfield 414 and a heading subfield 416. The travel path array 408 is a dynamic array including successive latitude/longitude pair (La, Lo) fields 418 along which the sprayer 100 will automatically travel.

The task data structure 402 includes a plurality of task records 420 which relate to respective tasks which are able to be performed by the sprayers 100. Each task record 420 includes a task identification field 422 which relates to the unique identity of each task to be performed and a task starting pose field 424 which relates to the starting pose of the task. The task starting pose field 424 include a latitude subfield 426, a longitude subfield 428 and a heading subfield 430.

Each task record 420 further includes a boolean task status field 432 which indicates whether the status of the task is “incomplete” whereby the sprayers 100 can bid in relation to performing the task or “complete” whereby the sprayers cannot bid in relation to performing the task.

Each task record 420 further includes a boolean bid status field 434 which indicates whether the status of the bid is “locked” whereby a successful bid has been determined or “unlocked” whereby the sprayers 100 can place bids in relation to the task.

Each task record 420 further includes a vehicle identity field 434 which includes the identity of the sprayer 100 which placed the successful bid in relation to the task.

Each task record 420 further includes a vehicle bid array 438 which is a dynamic array. The vehicle bid array 438 includes vehicle bid subfields 440 relating to respective sprayers 100 and containing the latest sprayer bids in relation to the task.

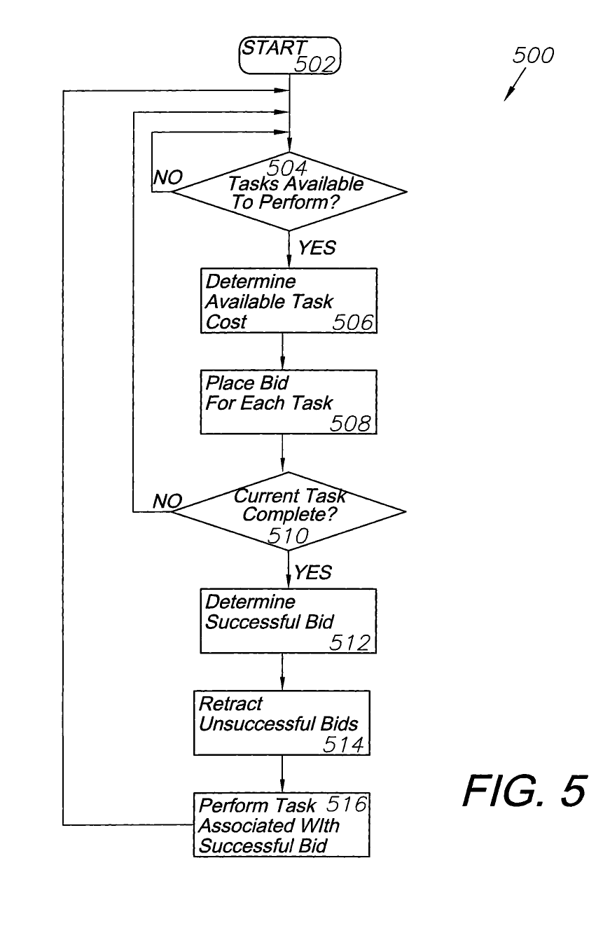

FIG. 5 shows the control method 500 for controlling each sprayer 100 using its controller 300 executing software product 302.

Initially, the sprayer 100 is spraying a current crop swath 104. As previously explained, the command centre 204 can at any time place in the database 304, one or more task records 420 relating to future tasks which may be performed.

At query step 504, the controller 300 queries whether at least one task record 420 is located in the database 304 with the task status field 432 set to “incomplete” and the bid status field 434 set to “unlocked”. If not, the controller 300 continues searching for a next task to perform by polling at step 504. If the controller 300 determines at least one available task to be performed at step 504, the method proceeds to step 506.

At step 506, the controller 300 determines a cost for performing each identified available task. Elaborating further, the cost is determined using the travel path distance field 410 to calculate either the distance of the sprayer 100 from a location where the task is to be performed or the travel time of the vehicle assembly to a location where the task is to be performed. The cost is generally proportional to the travel path distance field 410 whereby a lower cost increases the likelihood of a successful bid.

At step 508 the controller 300 places a bid for each available task, with the bid being placed in accordance with the determined cost. Elaborating further, the controller 300 places the determined costs in the vehicle bid subfield 440 of the vehicle bid array 438 for each available task record 420.

At query step 510, the controller 300 queries whether the sprayer 100 has completed its current task. If the sprayer 100 has not completed its current task, the method 500 returns to step 504. If the sprayer 100 has completed its current task and is ready to perform another available task related to a task record 420, the method 500 proceeds to step 512.

At step 512 and for a given task record 420, the controller 300 determines that a placed bid in the vehicle bid subfield 440 was successful when compared with bids in other bid subfields 440 associated with other vehicle sprayers 100. Elaborating further, the successful bid would be the lowest cost bid placed when compared with the bids of any other sprayers 100. If the controller 300 determines that the sprayer 100 has placed successful bids for multiple tasks associated with respective task records 420, then the lowest successful bid is the sole successful bid.

At step 514, the controller 300 controls the sprayer 100 to perform the task associated with the successful bid. For the task record 420 associated with the successful bid, the controller 300 sets the bid status field 434 to “locked” and the vehicle identity field 434 is loaded with an identifier corresponding to the sprayer 100.

While performing the task associated with the successful bid, the controller 300 returns to step 504 to obtain a next available task to perform. Once the task associated with the successful bid is completed, the controller 300 sets the related task status field 432 of the task record 420 to “complete”.

The working of the control method 500 of FIG. 5 is now described by way of example with reference to FIG. 2. The method 500 is performed concurrently by the controllers 300a, 300b of respective sprayers 100a, 100b.

Initially as shown in FIG. 2, sprayer A 100a is about to complete spraying swath W 104a and sprayer B 100b is beginning to spray swath Y 104c. The command centre 204 has placed in the database 304, task record 420a relating to spraying swath X 104b and task record 420b relating to spraying swath Z 104d.

At query step 504, each controller 300 determines that both task records 420a, 420b have their task status field 432 set to “incomplete” and their bid status field 434 set to “unlocked”. Accordingly, each controller 300 determines that the tasks of spraying swath X 104b and swath Z are available.

At step 506, each controller 300 determines a cost for performing each identified available task and places a corresponding cost bid at step 508. In the present example shown in FIG. 2, the cost bid (i.e. 9.5) in the vehicle bid subfield 440a (i.e. Sprayer A 100a) for the available task record 420a (i.e. swath X 104b) is less than the cost bid (i.e. 50.4) in the vehicle bid subfield 440a (i.e. Sprayer A 100a) for the available task record 420b (i.e. swath Z 104d). The cost bids (i.e. 15.3) are the same in the vehicle bid subfields 440b (i.e. Sprayer B 100b) for both available task records 420a, 420b (i.e. swath X 104b and swath Z 104d),

At query step 510, the controller 300a of sprayer A 100a determines that it has completed its current task of spraying swath W 104a and the method 500 proceeds to step 512. However, the controller 300b of sprayer B 100b determines that it has not completed its current task of spraying swath Y 104c and the method 500 returns to step 504.

At step 512 and for a given task record 420a (i.e. swath X 104b), the controller 300a of sprayer A 100a determines that a placed bid (e.g. 9.5) in the vehicle bid subfield 440a was successful when compared with the higher bid (e.g. 15.3) in the subfield 440b associated with sprayer B 100b. For task record 420b (i.e. swath Z 104d), the controller 300a of sprayer A 100a also determines that a placed bid (e.g. 50.4) in the vehicle bid subfield 440a was not successful when compared with the lower bid (e.g. 15.3) in the subfield 440b associated with sprayer B 100b.

At step 514, the controller 300a controls the sprayer 100a to perform the task of traveling to and subsequently spraying swath X 104b associated with the successful bid. For the task record 420a associated with the successful bid, the controller 300a sets the bid status field 434 to “locked” and the vehicle identity field 434 is loaded with an identifier (e.g. “Sprayer A”) corresponding to the sprayer A 100a.

While spraying swath X 104b, the controller 300a of sprayer 100a returns to step 504 to obtain a next task to perform. Once spraying of swath X 104b is completed, the controller 300a sets the related task status field 432 of task record 420a to “complete”.

A person skilled in the art will appreciate that many embodiments and variations can be made without departing from the ambit of the present invention.

While the spraying system 200 described above included only two sprayers 100a, 100b, the skilled person will understand that the system is readily scalable to include further sprayers 100 which also act as automatons.

In the preferred embodiment, the database 304 included many mirrored local versions at respective locations. In an alternative embodiment, the database 304 is instead located at a single location.

In the preferred embodiment, the local versions of the database 304 were periodically synchronized. In an alternative embodiment, event based synchronization may be instead employed whereby synchronization of data among the versions only occurs when data in a local version of the database is altered.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A method for controlling a vehicle assembly using a controller, the method including the steps of:
placing, with the controller, a bid in relation to an task to be performed by the vehicle assembly;
determining, with the controller, that the placed bid was successful; and
controlling, with the controller, the vehicle assembly to perform the task subsequent to determining that the placed bid was successful.

2. A method as claimed in claim 1 which, prior to the step of placing, further includes the step of identifying the task to be performed.

3. A method as claimed in claim 2, wherein the step of identifying involves searching or polling.

4. A method as claimed in claim 1 which, prior to the step of placing, further includes the step of determining a cost for performing the task, the bid being placed in accordance with the determined cost.

5. A method as claimed in claim 4, wherein the cost is determined using database information to calculate one of: the distance of the vehicle assembly from a location where the task is to be performed, or the travel time of the vehicle assembly to a location where the task is to be performed.

6. A method as claimed in claim 5, wherein the step of determining a cost involves determining a travel path of the vehicle assembly to the location where the task is to be performed.

7. A method as claimed in claim 1, wherein the step of determining that the placed bid was successful involves determining that the bid associated with the vehicle assembly was a lowest cost bid placed for the task when the vehicle assembly is ready to perform the task.

8. A method as claimed in claim 1 which, prior to the step of placing, further includes the step of placing a succession of prior bids in relation to the task, the step of determining involving determining that the placed bid was successful when compared with bids from one or more other vehicle assemblies.

9. A method as claimed in claim 8, wherein each step of placing involves placing a bid in a bid field of the database associated with the vehicle assembly.

10. A method as claimed in claim 1, wherein the task to be performed is spraying a crop swath using a sprayer of the vehicle assembly, and the step of controlling involves spraying the crop swath.

11. A method as claimed in claim 1, further including the step of updating a database of the controller using synchronization information so that the database mirrors databases of other vehicle assembly controllers.

12. A method as claimed in claim 11, wherein the step of updating the database is performed periodically.

13. A method as claimed in claim 1, further including the step of placing another bid in relation to another potential task to be performed by the vehicle assembly.

14. A method for controlling vehicle assemblies using respective controllers, each controller in communication with a database, each controller configured to perform the steps of:
placing a bid in the database in relation to a task to be performed by the vehicle assembly;
determining whether the placed bid was successful; and
controlling the vehicle assembly to perform the task subsequent to determining that the placed bid was successful.

15. A method as claimed in claim 14, wherein the database includes task records relating to respective tasks to be performed, and each controller is configured to place one or more bids in the database in relation to respective tasks.

16. A method as claimed in claim 14, wherein:
the database receives a succession of cost bids for first and second vehicle assemblies; and
when the first vehicle assembly is ready to perform the task, the first vehicle assembly can determine that its most recent cost bid is successful as it is lower than the most recent cost bid of the second vehicle assembly.

17. A method as claimed in claim 14, wherein the database is distributed with mirrored and synchronized versions of the database being located proximal to respective controllers.

18. A method as claimed in claim 14, wherein the database is located at a single location.

19. A vehicle controller for controlling a vehicle assembly, the controller configured to:
place a bid in relation to a task to be performed by the vehicle assembly;
determine that the placed bid was successful; and
control the vehicle assembly to perform the task subsequent to determining that the placed bid was successful.
